(19) United States
(12) Patent Application Publication
(10) Pub. No.: US 2018/0220592 A1
(43) Pub. Date: Aug. 9, 2018

(54) METHOD AND SYSTEM FOR PLANT GROWTH LIGHTING

(71) Applicant: Argia Group LLC, Austin, TX (US)

(72) Inventors: Thomas Gilley, Austin, TX (US); Mark Walsh, Austin, TX (US)

(21) Appl. No.: 15/887,928

(22) Filed: Feb. 2, 2018

Related U.S. Application Data
(60) Provisional application No. 62/454,644, filed on Feb. 3, 2017.

(51) Int. Cl. A01G 7/04; A01G 9/20; A01G 9/24; A01G 25/16; F21S 10/02; F21V 23/00; G01J 3/46

(52) U.S. Cl. CPC A01G 7/045; A01G 9/20; A01G 9/24; F21Y 2115/10; F21S 10/02; F21V 23/003; G01J 3/46; A01G 25/167

(57) ABSTRACT

A method and system for plant growth lighting. The method comprises accessing a reference growth profile associated with a plant under cultivation. Based on comparing a growth state of the plant with the reference growth profile, a desired intraday growth lighting condition corresponding to the plant growth state is identified. The desired intraday growth lighting condition is correlated with a spectral output frequency signature of the LED growth lighting source. The desired intraday growth condition is simulated by providing lighting including the correlated spectral output frequency signature from the LED lighting source to the plant under cultivation.

### RELATED APPLICATIONS

This application claims benefit of priority to U.S. Provisional Patent Application No. 62/454,644, filed Feb. 3, 2017; the aforementioned priority application being hereby incorporated by reference in its entirety for all purposes.

### BACKGROUND

It has become increasingly feasible for light-emitting diodes (LED) to be used as lighting or irradiation sources to encourage or enhance plant growth. It is now possible using LED lighting sources for artificial and supplemental lighting, such as in artificial plant growth industrial complexes, to achieve a rate of plant growth that exceeds growth under natural sunlight conditions. LED lights are increasingly used for growing indoor crops as they provide a bright, cost-effective and long lasting light that can provide varying spectral output wavelengths of light that are essential to, and absorbed during, the photosynthetic process essential to plant growth. LEDs have become sufficiently inexpensive and bright in intensity for deployment as irradiation sources in a greenhouse environment. Additionally, as LED sources consume a relatively small amount of power, using an LED-based illumination system minimizes the amount of collaterally-generated heat, a result that is desirable in a greenhouse environment where temperature control is important.

### BRIEF DESCRIPTION OF THE DRAWINGS

FIG. 1 illustrates an example arrangement of a plant growth lighting system.

FIG. 2 illustrates an example, in further detail, of components included in a plant growth lighting system.

FIG. 3 illustrates an example method of deploying a plant growth lighting system.

### DETAILED DESCRIPTION

Examples include a method for plant growth lighting by way of providing suitable photosynthetically active radiation (PAR) values and selected combinations of spectral output from LED growth lighting sources onto targeted plants or plant surfaces under cultivation. The method comprises accessing a reference growth profile associated with a plant under cultivation. Based on comparing a growth state of the plant with the reference growth profile, a desired intraday growth lighting condition corresponding to, or optimally suited to enhancing, the plant growth state may be identified. The desired intraday growth lighting condition is correlated with a spectral output frequency signature of the LED growth lighting sources. The desired intraday growth condition is simulated by providing lighting including the correlated spectral output frequency signature from the LED lighting sources to the plant under cultivation. Among other benefits, LED growth lighting having a unique combination of spectral output emissive wavelengths most suited to plant development at a given stage may be deployed, thereby to simulate particular intraday growth conditions most advantageous for plant cultivation at that given stage, irrespective of prevailing daily or seasonal external growing conditions.

Other examples include a system for plant growth lighting. The system includes an LED growth lighting source coupled to a controller computing device such as a server or a computer workstation including a processor in communication with a memory storing computer instructions executable in the processor. The instructions are executable in the processor to access a reference growth profile particular to a plant species under cultivation. Based on comparing a growth state of the plant with the reference growth profile, a desired intraday growth lighting condition corresponding to the plant growth state may be identified. The desired intraday growth lighting condition may be correlated with a spectral output frequency signature of the LED growth lighting source. The desired intraday growth condition may be simulated by providing lighting including the correlated spectral output frequency signature from the LED lighting source to the plant under cultivation. Examples of intraday growth conditions may correspond to a morning, a midday, or an evening non-darkness conditions, in some embodiments. Among other benefits, having an integrated plant growth ecosystem allows the plant grower to alter the attributes of the plant to achieve desired results. For instance, the amount of red wavelengths can be varied to have red leaf lettuce grow without a red coloration, and the taste profile can be changed to achieve a desired flavor. The ability to control elements of the growth ecosystem, including (but not limited to) lighting, temperature, and humidity, makes it possible for growers to seek and achieve enhanced attributes of the target crop, such as appearance, texture, and taste.

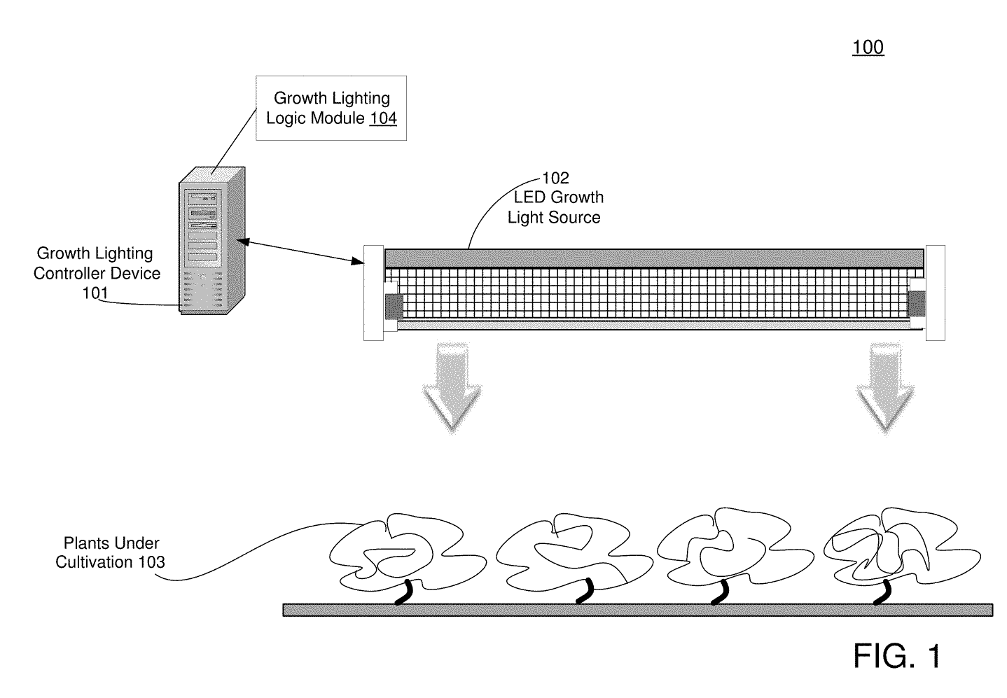

FIG. 1 illustrates plant growth lighting system 100, in an example embodiment. System 100 includes LED growth lighting source 102 coupled to controller computing device 101, which may be implemented as a computer workstation or a computer server including a user interface display and user input means, and having a memory storing computer instructions in accordance with growth lighting logic module 104. Light illumination from LED growth lighting source 102 irradiates onto plant surfaces of plants under cultivation 103, providing photosynthetically active radiation at emissive wavelengths inherent to the individual color of LEDs, or color of LED subsets, of which LED growth lighting source 102 is configured, for photosynthetic absorption by the plant surfaces. As used herein, the term LED is intended to encompass all technology forms and configurations of light emitting diodes, including organic light emitting diodes (OLED), capable of providing photosynthetically active irradiation to plants under cultivation. It is further contemplated that other semiconductor technologies, such as quantum dots, may be applied using the techniques and systems described herein to provide different colors of photosynthetic lighting, at inherently different irradiation frequencies, to plants under cultivation.

In variations, the illumination characteristics of LED growth lighting source 102 may be selected to achieve a generally constant-PAR value, for example, around 500 micro-moles in one embodiment, using a combination of white LEDs such as cool white and warm white. It is contemplated that selection of an optimum PAR value in this manner may provide the plant under cultivation with a readily-absorbable amount of irradiation energy while simultaneously minimizing the power or energy consumption by LED growth lighting source 102. White light, by its nature is composed of all of the visible light spectrum. However, the mix of spectrums can vary greatly. White light is measured in Correlated Color Temperature (CCT) values. The terms cool white and warm white may be specified according to a range of CCT values related to the color of light emitted from the white light LED source. For instance, white light LED sources having (relatively) low CCT values ranging from 2,700K to 3,000K provide light that appears “warm”, while white light LED sources having high CCT values ranging from 4,000K to 6,500K provide light that appears “cool”. Warm white LEDs tend to have a predominant amount of red light in terms of spectral emission and attendant emissive wavelength. Cool white LEDs, in contrast, tend to have a predominant amount of blue light in their spectrum, and are therefore capable of providing a higher amount or a higher concentration of the blue light emissive wavelength associated therewith. Thus, particular combinations of cool white and warm white LEDs can be tailored and applied to achieve a desired or target PAR value or spectral output frequencies to cater for irradiation absorption needs of a given plant species under cultivation, and to emulate specific intraday growth conditions which can enhance plant development in view of the current state or stage of plant development, for example. In variations, the above described technique of using combinations of white LEDs having different CCT values, and also red and blue LEDs within LED growth lighting source 102 may be implemented not only in panel lighting configurations, but also via flood lighting and spot lighting configurations using LEDs. White, including cool and warm whites, blue and red LED color configurations or subsets of LED configurations, within LED growth lighting source 102 may also include other colors or color combinations, including, but not limited to, amber and green LEDs, for example.

In further embodiments, the above described system of using combinations of white LEDs having different CCT values, and optionally red, blue, amber and green LEDs, may be implemented not only in panel lighting configurations, but also in flood lighting and spot lighting configurations using LEDs in order to provide varying spectral outputs of growth lighting from the LED source lighting. Color LEDs are usually described with reference to their dominant wavelength, whereas they actually emit irradiation over a wavelength range or band. For instance, red color LEDs typically emit irradiation in a wavelength range from 640 nm to 660 nm, with the dominant wavelength at 650 nm. Similarly, amber, yellow, orange and green LEDS when included or combined with red, blue, warm white and cool white LEDs in the LED growth lighting source add a spectral output respectively inherent to those specific colors. Thus, depending on the particular color combinations deployed, a spectral output from a particular combination of LEDs may be configured to provide a growth lighting spectral output having a unique frequency signature of emissive wavelengths, the frequency signature being characterized in accordance with emissive wavelengths inherent to the LED colors providing the illumination or irradiation.

In further variations, the spectral output of the LED growth lighting source may be programmable to adjustably provide a non-darkness growth lighting condition that simulates at least one of a morning, a midday, and an evening lighting conditions. A non-darkness evening lighting condition may correspond to, or range from, an early to advanced dusk time of day, in some examples. In some intraday characterizations, the morning and evening lighting conditions include predominantly red color emissive wavelengths, while the midday lighting condition are characterized by predominantly blue color emissive wavelengths. Yet further, in this manner, any of the morning, midday or evening LED growth lighting conditions may be applied to achieve prolonged or decreased periods of simulated morning, midday and evening growth conditions respectively.

In other examples, the different subsets of LEDs, or even individual LEDs within a given subset within LED growth lighting source 102 may be independently controllable for independent operation via suitable programmable controls in accordance with growth lighting logic module 104 of growth lighting controller device 101 in electrical operation. For example, On/Off states and brightness intensity levels of individual LEDs, or subsets of LEDs of a given color and spectral output or photosynthetic emissive wavelength characteristics, may be adjusted in accordance with predetermined or programmable settings depending on the photosynthetic spectral output needs inherent to a plant under cultivation at a given stage of growth.

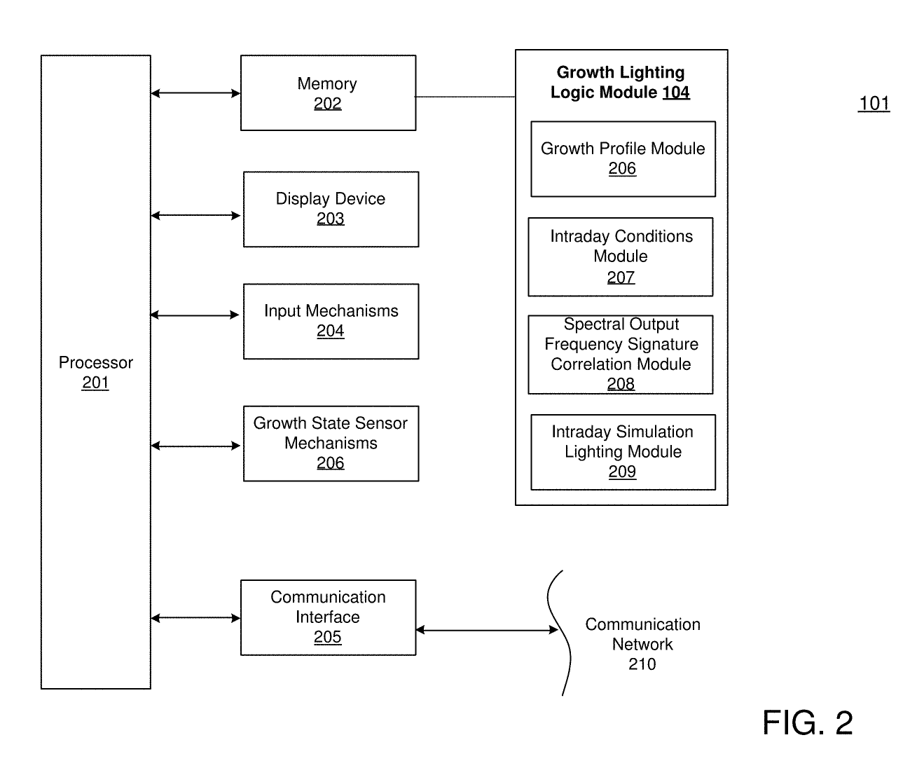

FIG. 2 illustrates an example architecture 200 in further detail of components of growth lighting controller device 101 of plant growth lighting system 100. FIG. 2 illustrates an example architecture of growth lighting controller device 101 for implementing an embodiment of plant growth lighting system 100. Growth lighting controller device 101, in an embodiment architecture, may be implemented on one or more computer server or other computing devices, and includes processor 201, memory 202 which may include a read-only memory (ROM) as well as a random access memory (RAM) or other dynamic storage device, display device 203, user input mechanisms 204 and communication interface 205 for communicative coupling to communication network 210. Processor 201 is configured with software and/or other logic, such as growth lighting logic module 104, to perform one or more processes, steps and other functions described with implementations, such as described by FIGS. 1 through 3 herein, and elsewhere in the application. Processor 201 may process information and instructions stored in memory 202, such as provided by a random access memory (RAM) or other dynamic storage device, for storing information and instructions which are executable by processor 201. Memory 202 also may be used for storing temporary variables or other intermediate information during execution of instructions to be executed by processor 201. Memory 202 may also include the ROM or other static storage device for storing static information and instructions for processor 201; a storage device 740, such as a magnetic disk or optical disk, may be provided for storing information and instructions. Communication interface 205 enables growth lighting controller device 101 to communicate with one or more communication networks 210 through use of the network link (wireless or wired). Growth state sensors or sensor mechanisms 206 may be deployed in connection with processor 201 to acquire data related to the growth state of the plant under cultivation, so that healthy or abnormal growth can be detected at any desired stages during plant development and cultivation. In embodiments, growth state sensors or sensor mechanisms 206 may include such as a foliage color sensor or camera to detect color anomalies of the plant foliage, a foliage size sensor or camera to detect foliage size characteristics as the plant develops, and a humidity sensor, a temperature sensor, and a water flow rate sensor to capture environmental or input conditions that may influence healthy or abnormal plant growth, at various stages of plant development.

Growth lighting logic module 104 of growth lighting controller device or server 101 may include instructions stored in RAM of memory 202 that are executable by processor 201, and includes growth profile module 206, intraday conditions module 207, spectral output frequency signature correlation module 208 and intraday simulation lighting module 209.

Processor 201 uses executable instructions stored in growth profile module 206 to access a reference growth profile particular to a plant under cultivation. In some embodiments, the reference growth profile may be stored in a database within memory 202 of growth lighting controller device or server 101, or may be remotely accessible from a database cloud server or other cloud computing device via communication interface 205 and communication network 210. The reference growth profile may specify optimal growth-related parameters related to development of a plant at various stages of growth during cultivation, such as might be associated with a healthy, normal growth cycle of the specific plant.

Processor 201 uses executable instructions stored in intraday conditions module 207 to compare a growth state of the plant at a given point in time with the reference growth profile as accessed. The growth state of the plant under cultivation may be detected via one or more sensor mechanisms 204, including, but not limited to, a plant foliage color sensor, a plant foliage size sensor, a humidity sensor, a temperature sensor, and a water flow rate sensor. Filters or pixel analysis can be employed to determine any deviations in the plant foliage color for early indications of disease or pestilence. Based on deviations or conformance with the reference profile characteristics, changes to then-existing conditions can be inferred to correct any growth anomalies or further enhance growth and development of the plant under cultivation.

Processor 201 uses executable instructions stored in spectral output frequency signature correlation module 208 to correlate the desired intraday growth lighting condition with a spectral output frequency signature to be provided by LED growth lighting source 102. For instance, particular photosynthetic spectral output frequencies of LED lighting can be identified to correct any growth anomalies or further enhance growth and development of the plant under cultivation. In some embodiments, a desired intraday growth lighting condition may be correlated to a plant growth state spectral output frequency signature to be provided by LED growth lighting source 102 necessary for enhancing growth or correcting any growth anomalies. Particular LED color combinations activated within LED growth lighting source 102 may be used to provide a growth lighting spectral output having a unique frequency signature of emissive wavelengths depending on inferred photosynthetic plant needs, the frequency signature being characterized in accordance with emissive wavelengths inherent to the LED colors activated in providing the illumination or irradiation. The intraday growth lighting condition provided by LED growth lighting source 102 may simulate at least one of a morning, a midday, and an evening lighting conditions, in some embodiments. In further embodiments, the morning and evening lighting conditions include predominantly red color emissive wavelengths, while the midday lighting condition includes predominantly blue color emissive wavelengths within the spectral output.

Processor 201 may use executable instructions stored in intraday simulation lighting module 209 to simulate the desired intraday growth condition by providing lighting including the growth lighting frequency signature from LED lighting source 102 to the plant under cultivation. The intraday growth lighting condition may simulated by providing the spectral output frequency signature that includes a red color having an emissive wavelength ranging from 650 nm to 700 nm and a blue color having an emissive wavelength ranging from 400 nm to 480 nm in some embodiments. The spectral output frequency signature may further include, or may be supplemented with, at least one of an amber and a green color LEDs having emissive wavelengths respectively inherent thereto. In some embodiments, a desired coloration of the foliage of the plant under cultivation, such as lettuce, may be achieved by emphasizing and applying a particular intraday growth condition predominantly. For instance, in some embodiments, using more blue or cool white wavelengths in the spectral output for longer periods to simulate lengthened periods of midday growth conditions during the intraday growth cycle, in order to reduce red coloration of the lettuce foliage. In further variations, the cultivation and LED irradiation environment may be programmed using the techniques described herein to simulate intra-year seasons to induce flowering or other targeted growth attributes for the plant growth cycle.

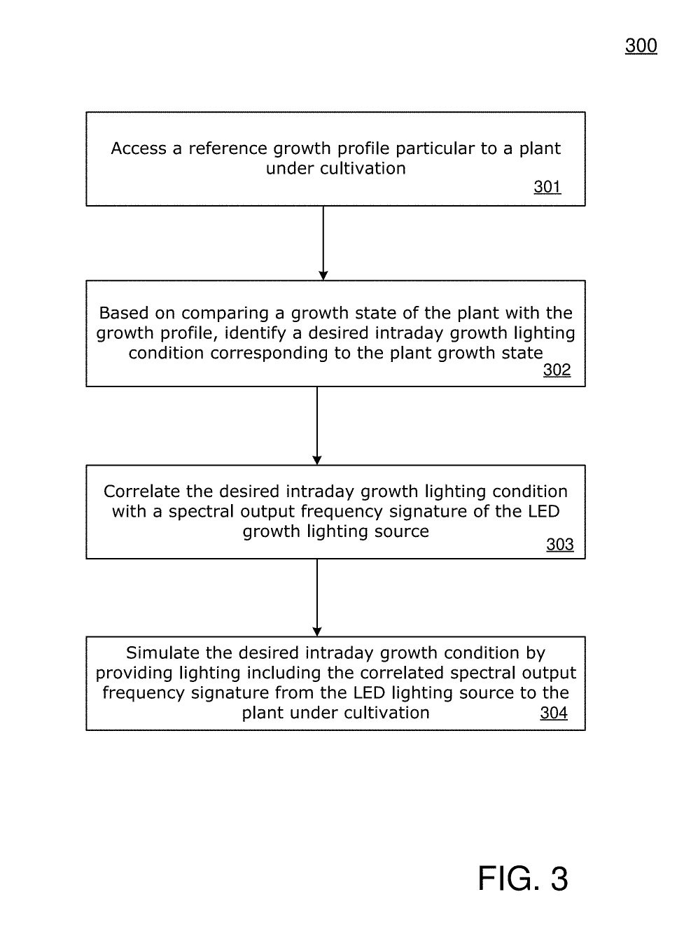

FIG. 3 illustrates an example method 300 of deploying plant growth lighting system 100. In describing the example of FIG. 3, reference is made to the examples of FIGS. 1-2 for purposes of illustrating suitable components or elements for performing a step or sub-step being described.

At step 301, accessing a reference growth profile associated with a plant under cultivation. the reference growth profile may be stored in a database within memory 202 of growth lighting controller device or server 101, or may be remotely accessible therefrom via communication interface 205 and communication network 210. The reference growth profile may specify optimal growth-related parameters related to development of a plant at various stages of growth during cultivation, such as might be associated with a healthy, normal growth cycle of the specific plant.

At step 302, based on comparing a growth state of the plant with the reference growth profile, identifying a desired intraday growth lighting condition corresponding to, or for enhancing, the plant growth state. The growth state of the plant under cultivation may be detected via one or more sensor mechanisms 204, including, but not limited to, a plant foliage color sensor, a plant foliage size sensor, a humidity sensor, a temperature sensor, and a water flow rate sensor. Filters or pixel analysis can be employed to determine any deviations in the plant foliage color for early indications of disease or pestilence. Based on deviations or conformance with the reference profile characteristics, changes to then-existing conditions can be inferred to correct any growth anomalies with a view to further enhance growth and development of the plant under cultivation.

At step 303, correlating the desired intraday growth lighting condition with a spectral output frequency signature of LED growth lighting source 102. In examples, profiling and color analysis can be used as indicators of when to adjust the irradiation spectral output or frequency signatures to induce desired next stage of growth. Particular combinations of cool white and warm white LEDs can be tailored and applied to achieve a desired or target PAR value or spectral output frequencies to cater for irradiation absorption needs of a given plant species under cultivation, and to emulate specific intraday growth conditions which can enhance plant development in view of the current state or stage of plant development, for example. In variations, the above described technique of using combinations of white LEDs having different CCT values, and also red and blue LEDs within LED growth lighting source 102 may be implemented not only in panel lighting configurations, but also via flood lighting and spot lighting configurations using LEDs. White, including cool and warm whites, blue and red LED color configurations or subsets of LED configurations, within LED growth lighting source 102 may also include other colors or color combinations, including, but not limited to, amber and green LEDs, for example. Accordingly, the frequency signature of the irradiation from LED growth lighting source 102 will be a combination of all photosynthetic emissive frequencies inherent in the LEDs activated o irradiate the plant. In some embodiments, one or more photosynthetic emissive frequencies within the frequency signature may be more prevalent or dominant than others. In some embodiments, the morning and evening intraday lighting conditions include predominantly red color emissive wavelengths, while the midday lighting condition includes predominantly blue color emissive wavelengths. In other examples, the intraday growth lighting condition may be provided at a generally constant-PAR value, for example, in one embodiment, the generally constant-PAR value may be about 500 micro-moles, to minimize power consumption by LED growth lighting source 102 while simultaneously ensuring that an optimal amount of readily-absorptive photosynthetic irradiation energy is provided to the plant under cultivation.

At step 304, simulating the desired intraday growth condition by providing growth lighting including the correlated spectral output frequency signature from LED lighting source 102 to the plant under cultivation. For instance, the intraday growth lighting condition is simulated by providing the spectral output frequency signature that includes a red color having an emissive wavelength ranging from 650 nm to 700 nm and a blue color having an emissive wavelength ranging from 400 nm to 480 nm among other LED irradiation or illumination colors.

For example, the spectral output frequency signature may further include at least one of an amber and a green LED colors having emissive wavelengths respectively inherent thereto. LED growth lighting source 102 may be independently controllable for independent operation via suitable programmable controls in accordance with growth lighting logic module 104 of growth lighting controller device 101 in electrical operation. For example, On/Off states and brightness intensity levels of individual LEDs, or subsets of LEDs of a given color and spectral output or photosynthetic emissive wavelength characteristics, may be adjusted in accordance with predetermined or programmable settings depending on the photosynthetic spectral output needs inherent to a plant under cultivation at a given stage of growth. In some embodiments, the spectral output of LED growth lighting source 102 is programmable and pre-set within intraday simulation lighting module 209 of growth lighting logic module 104, and thus may be made continuously adjustable to provide a non-darkness growth lighting condition that simulates at least one of a morning, a midday, and an evening lighting conditions. In further variations, the cultivation and LED irradiation environment may be programmed using the techniques described herein to simulate intra-year seasons to induce flowering or other targeted growth attributes for the plant growth cycle.

Although illustrative embodiments have been described in detail herein with reference to the accompanying drawings, variations to specific embodiments and details are encompassed by this disclosure. It is intended that the scope of embodiments described herein be defined by the claims and their equivalents. Furthermore, it is contemplated that a particular feature described, either individually or as part of an embodiment, can be combined with other individually described features, or parts of other embodiments. Thus, the absence of describing specific combinations should not preclude the inventor(s) from claiming rights to such combinations.

What is claimed is:

1. A method for plant growth lighting comprising:
accessing a reference growth profile associated with a plant under cultivation;
based on comparing a growth state of the plant with the reference growth profile, identifying a desired intraday growth lighting condition corresponding to the plant growth state;
correlating the desired intraday growth lighting condition with a spectral output frequency signature of a Light Emitting Diode (LED) growth lighting source; and
simulating the desired intraday growth condition by providing growth lighting including the correlated spectral output frequency signature of the LED lighting source to the plant under cultivation.

2. The method of claim 1 further comprising detecting the growth state of the plant under cultivation via at least one of a foliage color sensor, a foliage size sensor, a humidity sensor, a temperature sensor, and a water flow rate sensor.

3. The method of claim 1 wherein the intraday growth lighting condition provided by the LED growth lighting source simulates at least one of a morning, a midday, and an evening lighting conditions.

4. The method of claim 3 wherein the intraday growth lighting condition is simulated by providing the spectral output frequency signature that includes a red color having an emissive wavelength ranging from 650 nm to 700 nm and a blue color having an emissive wavelength ranging from 400 nm to 480 nm.

5. The method of claim 4 wherein the spectral output frequency signature further includes at least one of an amber and a green color having emissive wavelengths respectively inherent thereto.

6. The method of claim 5 wherein the morning and evening lighting conditions include predominantly red color emissive wavelengths.

7. The method of claim 5 wherein the midday lighting condition includes predominantly blue color emissive wavelengths.

8. The method of claim 3 wherein the intraday growth lighting condition is provided at a generally constant-Photosynthetic Available Radiation (PAR) value.

9. The method of claim 8 wherein the generally constant-PAR value is between 300 and 500 micro-moles.

10. The method of claim 3 wherein the LED growth lighting source includes a combination of warm white LEDs and cool white LEDs having a range of correlated color temperature (CCT) values ranging from 2,700K to 3,000K and from 4,000K to 6,500K respectively.

11. The method of claim 10 wherein the spectral output of the LED growth lighting source is continuously adjustable to provide a non-darkness growth lighting condition that simulates at least one of a morning, a midday, and an evening lighting conditions.

12. A growth lighting system comprising:
at least one processor;
a Light Emitting Diode (LED) growth lighting source controllable by the at least one processor; and
a memory coupled to the at least one processor, the memory including instructions executable by the at least one processor to:
access a reference growth profile particular to a plant under cultivation;
based on comparing a growth state of the plant with the reference growth profile, identify a desired intraday growth lighting condition corresponding to the plant growth state;
correlate the desired intraday growth lighting condition with a spectral output frequency signature of the LED growth lighting source; and
simulate the desired intraday growth condition by providing lighting including the correlated spectral output frequency signature from the LED lighting source to the plant under cultivation.

13. The system of claim 12 wherein the growth state of the plant under cultivation is detected via at least one of a color sensor, a foliage size sensor, a humidity sensor, a temperature sensor, and a water flow rate sensor.

14. The system of claim 12 wherein the intraday growth lighting condition provided by the LED growth lighting source simulates at least one of a morning, a midday, and an evening lighting conditions.

15. The system of claim 14 wherein the intraday growth lighting condition comprises a spectral output frequency signature that includes a red color having an emissive wavelength ranging from 650 nm to 700 nm and a blue color having an emissive wavelength ranging from 400 nm to 480 nm.

16. The system of claim 14 wherein the spectral output frequency signature further includes at least one of an amber and a green color having emissive wavelengths respectively inherent thereto.

17. The system of claim 16 wherein the morning and evening lighting conditions include predominantly red color emissive wavelengths.

18. The system of claim 16 wherein the midday lighting condition includes predominantly blue color emissive wavelengths.

19. The system of claim 14 wherein the intraday growth lighting condition is provided at a generally constant-Photosynthetic Available Radiation (PAR) value.

20. The system of claim 14 wherein the LED growth lighting source includes a combination of warm white LEDs and cool white LEDs having a range of correlated color temperature (CCT) values ranging from 2,700K to 3,000K and from 4,000K to 6,500K respectively.

21. The system of claim 20 wherein the spectral output of the LED growth lighting source is programmably adjustable to provide a non-darkness growth lighting condition that simulates at least one of a morning, a midday, and an evening lighting conditions.
